(19) United States
(12) Patent Application Publication
(10) Pub. No.: US 2025/0341942 A1
(43) Pub. Date: Nov. 6, 2025

(54) System to virtually view an environment or products inserted in an environment and process thereof

(71) Applicant: Gian Marcello Noia, Genova (IT)

(72) Inventor: Gian Marcello Noia, Genova (IT)

(21) Appl. No.: 19/268,649

(22) Filed: Jul. 14, 2025

Related U.S. Application Data
(63) Continuation-in-part of application No. 17/614,514, filed on Nov. 27, 2021.

(30) Foreign Application Priority Data
May 29, 2019 (IT) 102019000007482

(51) Int. Cl. G06F 3/04815; G06F 3/0486; G06T 1/20; G06T 17/00

(52) U.S. Cl. CPC G06F 3/04815; G06F 3/0486; G06T 1/20; G06T 17/00

(57) ABSTRACT

A system, and a related process using the system, to collaboratively view a virtual representation of an environment or of products inserted in an environment, includes two or more local stations, each comprising a processor, a memory, a monitor, and a data transmission and reception system; and a WEB server configured to store a digital replica of the environment composed of spatially anchored media objects, allow real-time bidirectional synchronization of directional indicators between the local stations, enable the placement and interaction with multimedia elements and contextual annotations within the environment, and adapt the graphical interface based on user role and session state.

### FIELD OF THE INVENTION

The present invention relates to a system for virtually viewing an environment or products placed in an environment and the related process.

### BACKGROUND OF THE INVENTION

Currently, if a seller wants to have a customer view a product, a factory, a transformation process, an apartment, or have them check and discuss the progress of a project, it is necessary to bring the customer on site to be able to provide him with the necessary information. Furthermore, existing solutions for virtual viewing are often limited to asynchronous or non-interactive presentations, lacking real-time feedback, directional guidance, and collaborative functionalities. These limitations hinder effective communication between operators and viewers, particularly in industrial or commercial settings requiring precise spatial references, state tracking, or role-based permissions.

### SUMMARY OF THE INVENTION

A system and the related procedure has been designed, which enables providing a real presence in a virtual world by exploiting the existing 360° image technology, without the need to view the object in question on the spot, using a PC or tablet or a viewer for virtual reality, now available everywhere at very low prices.

In practice, if a manager, whether he is a salesperson and/or a technician, needs to view something that is placed in an environment, thanks to the system and the procedure object of the present invention, he can easily do so by virtually immersing himself on the spot with a customer accompanying him on the visit as if he were actually in that place.

And in case the customer needs to participate with his technicians and/or guests, he can easily invite all the people he wants to the session, without having to physically bring everyone together in the place in question.

Furthermore, the system allows the manager to record session notes and share them automatically with one or more invited users by email, enabling collaborative decision-making and post-session review. This ensures traceability of communications and decision-making during or after the session. The system further supports integration of standard 2D images as an alternative to 360° images, ensuring operability even in environments where spherical imaging is not feasible or available.

The invention brings advantages that are obtained both in saving time and in economic savings due to the eliminated or at least enormously reduced need to physically go to the place in question, all assisted by a manager who in real time illustrates, explains and answers questions of the customer.

In addition, in certain situations a first virtual vision enables to quickly decide for the customer without making him spend additional time or let the manager spend it: for example in the case of environments the virtual vision of a shed, an apartment, a villa or a home may sometimes enables to quickly decide not to be interested or, on the contrary, to speed up the process of buying or renting (at this point followed by a possible inspection but with a fair possibility of sale or rent).

In fact, very often the customer visits more environments and more products, while in this way he would be able to sort more quickly what he is interested in without having to move.

A system according to the invention, for virtually viewing an environment or products placed in an environment, contains or essentially comprises the following devices:
at least two local stations containing the first at least one local PC with suitable devices or at least one tablet, the second at least one local PC with suitable devices or at least one tablet or at least one viewer;
a WEB server containing the virtual environment system with means for transmitting/receiving data and for transmitting/receiving mail.

The first station is the one available to the manager, while the second is the one available to the customer.

In this case, there may be additional workstations identical or similar to the first or second in the event of simultaneous use by other managers or customers respectively.

In particular, the at least two local stations could contain a local PC with suitable memory, a monitor, a keyboard, a mouse, a touch-screen and means for data transmission/reception.

Each local station can additionally include input/output interfaces enabling users to connect VR headsets, voice communication tools, and navigation controllers. The graphical interface on the user's station dynamically adapts based on the user's role (manager or guest), allowing different levels of control and access to the virtual environment's features.

The WEB server preferably comprises the following devices:
A central processor or central processing unit (CPU);
A graphics processor or Graphics processing unit (GPU);
An image signal processor (ISP);
Link commands for links to another page (LINK);
Memory or memories for programs, images, texts;
Video (VIDEO);
Means for sending images/data from the server to local stations (OUTPUT);
Means for sending instructions from local stations to the server (INPUT).

An additional feature of the present invention is the process for virtually viewing an environment or products placed in an environment, by means of the system described above, which method essentially comprises the following steps:
Accessing by a manager (employee or salesman) of the company to a web page created specifically for the company itself where there are various environments corresponding to what the manager wants to show the customer;
Choosing a specific environment selected by the manager and the consequent link by e-mail to person, the customer, who must view the said environment or products so that they can directly access the virtual environment;
Viewing the environment or said products by the customer through the link received from the manager;
Selecting, by the customer, details of environments or products by means of suitable commands so as to be able to view in greater detail all the allowed areas of the environment or of the selected product,
   this process being carried out both by enabling the customer to communicate directly with the manager and by enabling the manager to see in real time, in a specific frame of his monitor, what the customer is currently seeing.

In one embodiment, the manager can also generate a shareable URL, embed it within a corporate website, and allow clients to access a predefined virtual tour autonomously. Such a “manual mode” does not require synchronized sessions and supports marketing and pre-sales activities.

The user interface further allows project-based configuration: each session or environment is stored under a specific project, which can include multiple floor plans, virtual environments, and versions. Each project can contain chronological “states of progress”, which the manager can compare to assess work evolution over time.

The manager at any time may have the right to be able to enable and/or disable some detailed vision functions or data available to the customer.

Additionally, the system supports the management of progress states (“states of work progress”), allowing the user to create, store, and compare different temporal versions of a virtual environment. Images from successive phases can be overlaid on a floor plan or environment schema, each annotated with timestamps and labels, enabling real-time tracking and historical comparison of the work's evolution. Images can be recalled at any stage so the user can check the work progresses at any time.

The web page, which is created ad hoc for the company, can contain a series of 360° pictures or render if it were a 3D.

During a procedure according to the invention, the manager can:
Choose to take the customer around through a pre-established route with arrows;
Take the customer to a specific area of a property, structure or process by clicking directly on the diagram or technical diagrams. Images, including 360° photos or standard 2D photos, can be uploaded directly into the system and mapped onto architectural floor plans or technical diagrams by dragging and placing them on corresponding spatial references;
Take the customer around, in the case of a visit, through points within the photograph itself;
Take notes and record them;
Recall technical characteristics visible only to him;
Launch a 360° video and comment it in real time, with the possibility of including normal pictures, texts and audio within the 360° picture.

Also during the procedure, within the environment, the manager can draw attention to a detail: in this case, for example by clicking on the image, directional indicators such as arrows will appear in the client's monitor or viewer that suggests that he shall move along the desired direction.

The directional indicators (arrows) appear on both the manager's and the customer's screens in real time, guiding the customer's view toward a point of interest. This is achieved preferably using a low-latency event propagation protocol, such as WebSocket. Once the user aligns their view to the suggested direction, the arrow disappears, providing immediate feedback to the manager.

In reverse, the customer may click on any point of the scene to trigger a specific marker (e.g a blu bullet/point) on the manager's interface, requesting attention or clarification. This bidirectional communication system allows collaborative navigation without or with less need for verbal cues. The user interface allows the manager and the customer to insert multimedia content into the environment, including photos, videos, audio recordings, and interactive 3D vector objects. Such media can be linked to specific spatial points, becoming interactable markers that enrich the immersive experience. Icons and intuitive controls allow the addition, editing, and deletion of these elements without programming skills.

In one variant, the media types include audio notes, static images, pre-recorded videos, and 3D vector graphics objects that can be rotated or scaled. Media objects are tagged with metadata such as geolocation, creation timestamp, and user identifier, and are linked to specific coordinates within the environment. This allows seamless contextual media interaction.

The customer can also click and interact in this way with the manager to draw his attention, for example, to a detail.

In special cases, the customer's second workstation could also be located in the same offices as the manager, for example in the case of companies that sell products for other companies.

The system can also incorporate interactive geographic mapping, allowing users to geolocate virtual environments on digital maps, such as Google Maps. This feature supports orientation, logistical planning, and integration with geographic data services. Geolocation metadata can be extracted from 360° or 2D images can be automatically synchronized with the digital map view, allowing spatial correlation between virtual content and real-world locations. The geolocation interface allows project anchoring and navigation with reference to physical space.

Users or managers can define directional markers (e.g., arrows) within the virtual environment to guide the visit route. These markers can be oriented and adjusted via graphical interface and linked to specific scenes or locations, providing a customized, scenario-driven walkthrough experience.

The directional guidance feature allows the manager to define view paths by placing vector arrows over the environment images. The system configures these markers using a dynamic overlay module that records orientation angles and destination links. These parameters are stored in association with each arrow object, and when the customer interacts with one, the system triggers a scene transition based on the stored target reference. The marker's directionality is computed based on cursor vector at placement time and is editable via GUI tools.

The system is configured to allow the manager to upload visual content from multiple sources, including 360° cameras, mobile devices, and cloud storage, via a graphical user interface (GUI). Upon activation of the upload function, the system's processing unit allocates temporary memory buffers to process input files, extracts metadata (e.g., timestamps, geolocation), and indexes them in a project-specific database to allow subsequent spatial mapping and chronological comparison.

The computing system includes a construction module which, once activated by the manager through a designated GUI icon, loads a floor plan or diagram and initializes an object-placement engine. This engine, running in the system's processor, enables real-time drag-and-drop positioning of photos or media elements, assigning spatial coordinates to each item and updating a configuration structure such as a backend JSON configuration structure for tour generation. Each object is rendered with embedded navigation hooks that allow directional transitions and media interactions. The editor includes a drag-and-drop placement engine which converts GUI interactions into spatial mappings. Each interaction is interpreted by a placement parser, which records relative spatial coordinates on the floor plan grid and generates a structured configuration object. These objects are indexed in the backend spatial database to allow dynamic scene reconstruction, directional link computation, and zone-based interaction management.

The system's backend is further configured to manage “work progress states” by creating temporal snapshots of the environment configuration. Each snapshot is stored as a unique instance containing media-object references, timestamps, and user-defined labels. Upon loading a new progress state, the system can use a comparison engine to highlight differences between the current and previous states, using layered rendering and visual indicators such as numbering and color overlays, computed by the GPU in real time.

Each state-of-work progress instance can be generated via a “historical state manager” module, which captures the full spatial configuration of a project at a given timestamp, including the location, metadata, and hierarchy of all visual media objects. The system serializes these configurations into a version-controlled data structure (e.g., JSON format) that allows differential tracking and rollback.

When a new state is created, the comparison engine analyzes changes in object positions, metadata, and visibility against the immediately preceding state. This delta is visualized via layered rendering: unchanged areas are dimmed, added content is highlighted in green, and removed elements are outlined in red. Numeric markers and tooltips are automatically placed on modified items, and a timeline navigator lets users switch between versions.

GPU acceleration can be used to compute visual differences in real-time, using a fragment shader pipeline that overlays difference masks on top of the base floorplan or 360° environment. All changes are logged and time-stamped to provide an audit trail for construction or progress verification purposes.

The state manager also supports semantic tagging of milestones (e.g., “foundation complete”, “equipment installed”), which can be filtered via the UI or exported in structured formats (CSV, XML) for reporting or integration with BIM platforms.”

The system includes an optional geolocation module which interfaces with third-party mapping APIs (e.g., Google Maps API). When the user activates the geolocation tool, the system retrieves and displays views such as satellite or map view. A project anchor point is set via click, and the coordinates are stored in the system database. These coordinates are used for navigation context and can be linked with real-world GPS metadata extracted from photos, ensuring spatial coherence across virtual environments. The geolocation module interfaces with external APIs (e.g., Google Maps) such as via RESTful requests and maps the spatial data using geographic projection formats (e.g., WGS84). Each image or scene object can be anchored to a geographic coordinate, enabling contextual navigation. GPS metadata from 360° images is automatically extracted and associated to project elements, which supports map-based route computation, region-based filters, and proximity-based content activation.

The system includes a graphical user interface editor that enables the manager to upload multiple images and place them on a floor plan or schematic. The interface supports real-time interaction, allowing users to drag images into specific positions on the plan. The system records spatial coordinates and links them with media metadata (e.g., timestamp, type). Once the image placement is complete, a virtual tour can be automatically generated based on the user-defined spatial logic.

The editing interface includes a work-progress state manager which works closely with the aforementioned backend feature related to work progress states. Each state consists of a snapshot of the virtual environment at a particular moment, defined by a set of associated images and media. The system overlays these states on the same base plan, displaying differences through automatic annotations (e.g., numbering, highlights) and saving them with unique timestamps for future comparison or playback.

The computing engine includes a synchronization mechanism where arrows placed by the manager in the virtual environment are simultaneously displayed on the customer's screen. These visual cues can be direction-adjusted and linked to specific viewpoints. The system uses event-driven propagation to reflect these changes in both user interfaces in real time.

The user interface features a navigation toolbar composed of functional icons. These icons give access to various modules including map geolocation, project details, environment selection, note registration, and launch of 360° video or virtual reality sessions. The toolbar dynamically updates based on the user's permissions and the current context of interaction.

The disclosed system is configured to allow a non-programmatic (i.e. no need for writing code each time), modular configuration of a digital replica of a physical space. Through an interactive layout interface, the manager uploads image resources—such as 360-degree or planar photographs—and anchors them to specific zones of a schematic representation (e.g., a floor plan or process diagram). The anchoring mechanism computes relative spatial coordinates and assigns navigation links, which are serialized into structured configuration files e.g. in JSON or XML format. This enables automatic scene generation and movement logic without coding intervention, differing substantially from systems where links or paths are statically predefined. Unlike systems where the user navigates only via hyperlink-style transitions, the present system uses a spatial logic engine that allows the user to explore the environment non-linearly, moving freely in any direction defined by spatial coordinates. This approach permits a walkthrough experience based on physical layout continuity, rather than discrete scene jumps. In addition to JSON or XML configuration files, the system supports exporting project metadata in standard formats (e.g., CSV, IFC) to enable compatibility with external platforms for BIM (Building Information Modeling) or project management. The backend infrastructure includes version control for tracking changes across states of work.

In contrast to known virtual tour systems, which primarily support static scene linkage, the present system introduces a temporal management layer, enabling project progress tracking via discrete “work states.” As mentioned above Each state corresponds to a temporal capture of the environment and contains uniquely timestamped media and associated metadata (e.g., version ID, annotation layer). The engine allows users to compare two or more states overlaid on the same plan, highlighting content differences using GPU-based rendering techniques and color-coded segmentation. This capability transforms the system from a simple visual navigation tool into a real-time progress analysis platform. In addition to simple date-stamping, each state of progress can be indexed with semantic tags and custom milestones (e.g., “structure completed”, “pre-installation check”), enabling filtered comparison and reporting based on project phases. This structured tagging layer supports analytical processing and visual narrative reconstruction of the work evolution.

The system includes an interaction synchronization module that facilitates two-way visual communication between the manager and the client. When a directional marker (e.g., an arrow) is placed by the manager within the virtual space, its position and vector attributes (direction, target scene ID) are encapsulated into a command packet and transmitted in real time using an event-driven protocol such as WebSocket. On receipt, the client system renders the marker overlay with matched spatial alignment, enabling coordinated focus. This differs from existing asynchronous systems where clients explore independently, and no real-time shared spatial context is maintained.

A hierarchical access control structure is implemented to support differentiated roles in the system, allowing precise configuration of permissions per module. The GUI adapts dynamically to the role of the user-manager or guest-by modifying available tools, data visibility, and interaction privileges. Each function (e.g., insert marker, upload media, compare states, launch VR mode) is encapsulated in a service block callable via interface icons. These are mapped to backend handlers through a routing layer, which registers and authenticates the action before executing changes in the virtual environment. This modular and role-based architecture enables the system to be deployed across use cases including construction tracking, industrial inspections, and collaborative remote selling. Roles can include: administrator, editor, guest, and viewer. Each role has specific permissions associated with icons and toolbar modules. For example, guests can participate in VR sessions but cannot upload content or modify layouts, while editors can manage media but not access session logs.

Furthermore, the GUI dynamically adapts the user interface not only by role, but also based on project phase, environmental configuration, and real-time session status. For example, in a late-stage inspection scenario, certain editing functions may be automatically disabled for guest users while enabling annotation-only modes. This adaptive control logic is managed by a session context engine embedded in the server-side layer.

### BRIEF DESCRIPTION OF THE DRAWINGS

These and other characteristics and advantages of the present invention will become clearer from the following description of some embodiments illustrated in the attached drawings wherein:

FIG. 1 shows the Web Server system;

FIG. 2 shows the system comprising two local workstations, the first one of the manager and the second one of the customer, connected to the Web Server;

FIG. 3 shows one of the possible block diagrams of the process;

FIG. 4 shows a possible selection of the commands available to the customer;

FIG. 5 shows a ROI (Region Of Interest) selection available to the customer;

FIG. 6 shows possible command bars available to the customer or manager;

FIG. 7 shows the environment editor interface, where floor plans are displayed and media files can be dragged and placed interactively to construct a virtual environment tour;

FIGS. 8 to 10 illustrates different functionalities of the working system with views, contextual commands and contents.

### DETAILED DESCRIPTION OF EMBODIMENTS OF THE INVENTION

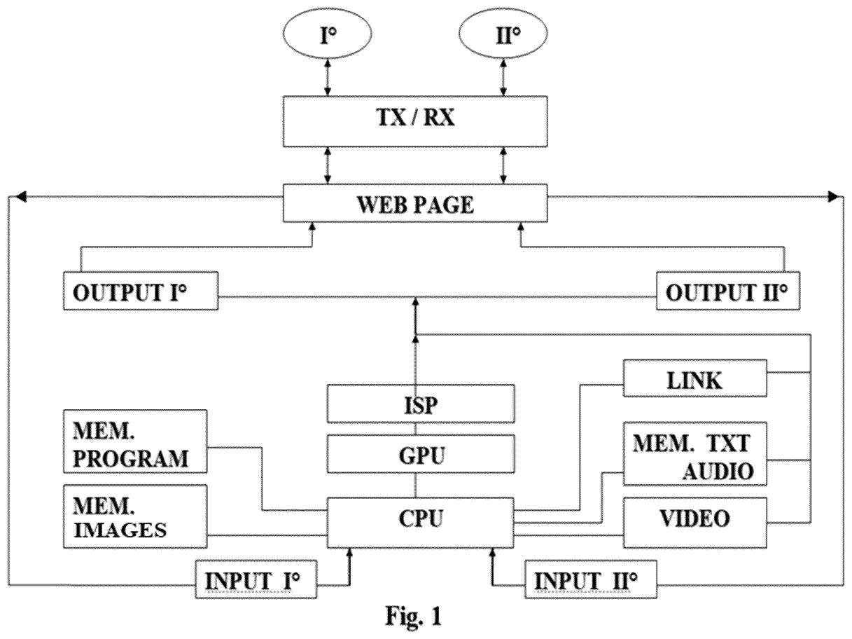

FIG. 1 shows the WEB SERVER which contains:
A central processor or central processing unit (CPU);
A graphics processor or graphics processing unit (GPU);
An image signal processor (ISP);
Link commands for links to another page (LINK);
Program memories (MEM.PROGRAM), images (MEM.IMAGES), audio texts (MEM TXT AUDIO);
Video (VIDEO);
Means for sending images/data from the server to local stations (OUTPUT);
Means for sending instructions from local stations to the server (INPUT).

The images/data (TX/RX) from the server through the OUTPUT means reach the stations of the manager (I°) and the customer (II°) through a WEB PAGE.

Both the manager and the customer can select the respective commands, defined differently for the two stations, in order to send the desired instructions (INPUT I°) and (INPUT II°) respectively to the server.

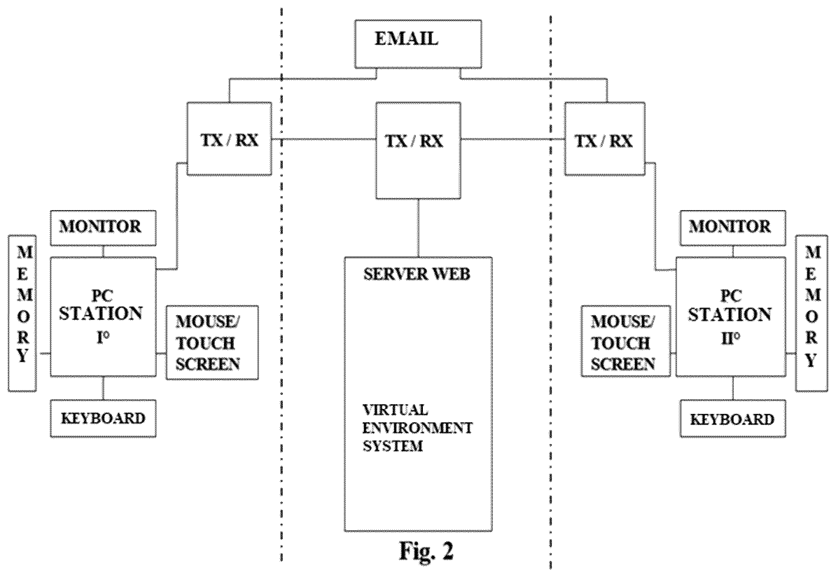

FIG. 2 shows the system comprising the two stations, that of the manager (I°) and that of the client (II°) connected to the Web Server. Both the manager's station (I°) and the client's station (II°) can include:
A LOCAL PC;
A MONITOR;
A KEYBOARD;
One or more MEMORIES;
A MOUSE and/or TOUCH-SCREEN;

Transmitting/receiving means (TX/RX).

These stations both communicate with the WEB SERVER through the transmitting/receiving means and possibly with a MAIL channel.

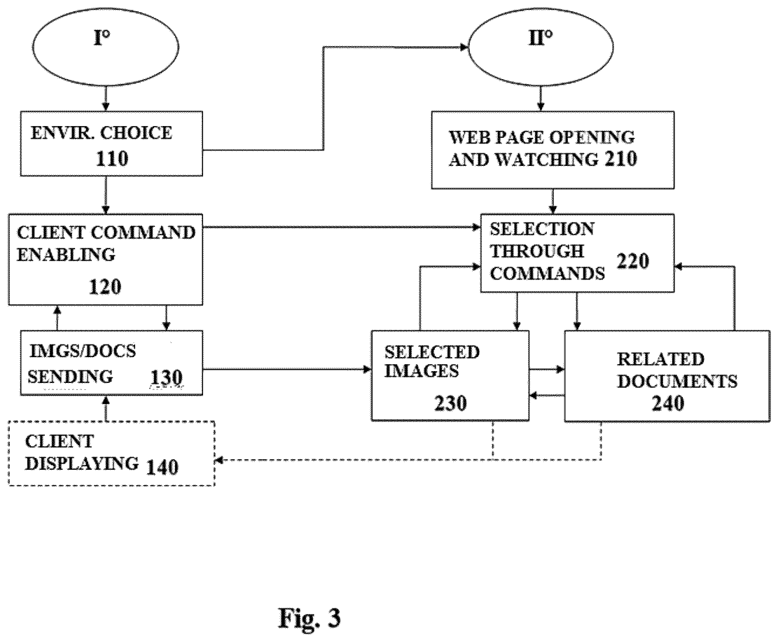

FIG. 3 shows a block diagram of the procedure where the manager (I°) accesses a web page, created specifically for the company, where he can find the various environments corresponding to what the manager wants to show the customer. He chooses the virtual environment to be viewed (Environment choice) (110) and sends an email to the customer with a link to directly access the virtual environment.

The manager can change the commands available to the customer based on the minimum or maximum information that he prefers to provide to the customer himself (Enable commands) (120).

The customer (II°), after opening the linked web page (Opening and viewing the web page) (210) can view the virtual environment and through available commands (Select by commands) (220) can decide to move, enlarge the selected area where he is most interested (Visions selected) (230) and possibly view the related documentation (TXT, Audio, Video) (Related documents) (240).

The manager can always see in real time what the customer is in particular seeing at that moment (Customer display) (140) (for example through a window on the monitor), while leaving the customer at the same time complete freedom of movement: in this way he may intervene or provide verbal clarifications and/or further related documentation to clarify/specify particular requests and/or make some choices of positioning details in order to help or direct the customer (Sending visions/documents) (130).

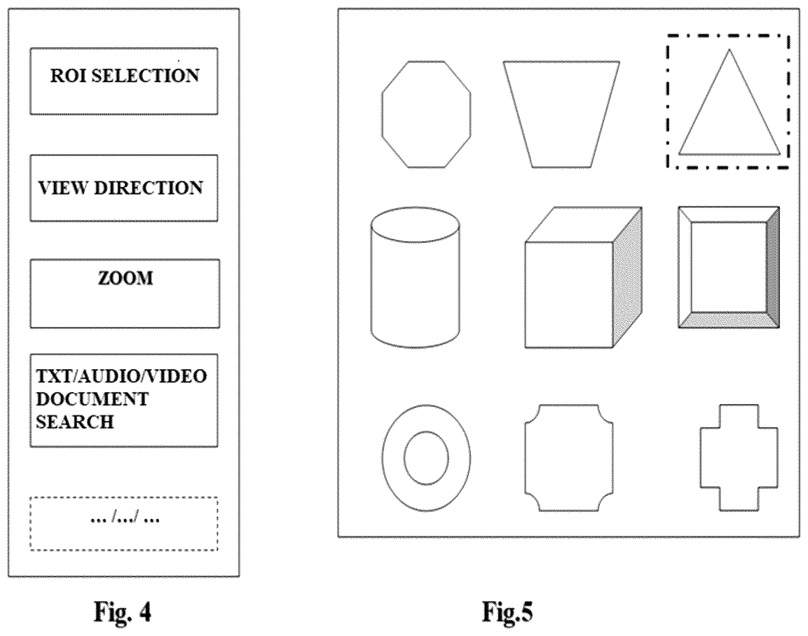

FIG. 4 shows a possible selection of the commands available to the customer in which the customer can, for example, make a selection of one of the objects (ROI SELECTION), a direction of view (DIRECTION OF VIEW), an enlargement of the product or area (ZOOM), or consult/download documentation (TX/AUDIO/VIDEO DOCUMENT SEARCH) or other commands.

In FIG. 5 the ROI (Region Of Interest) selection is made, for example, by selecting one of the objects in the monitor through the frame (which are represented in the figure with solids and geometric figures only for simplicity).

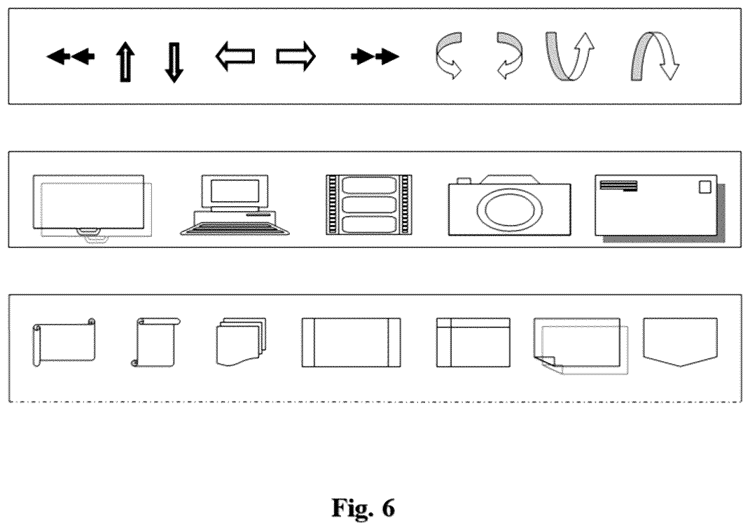

FIG. 6 shows three possible types of command bars, the first one to choose the direction of view by means of arrows, the second one to choose the means for storing data and the third one to choose the viewable documentation available.

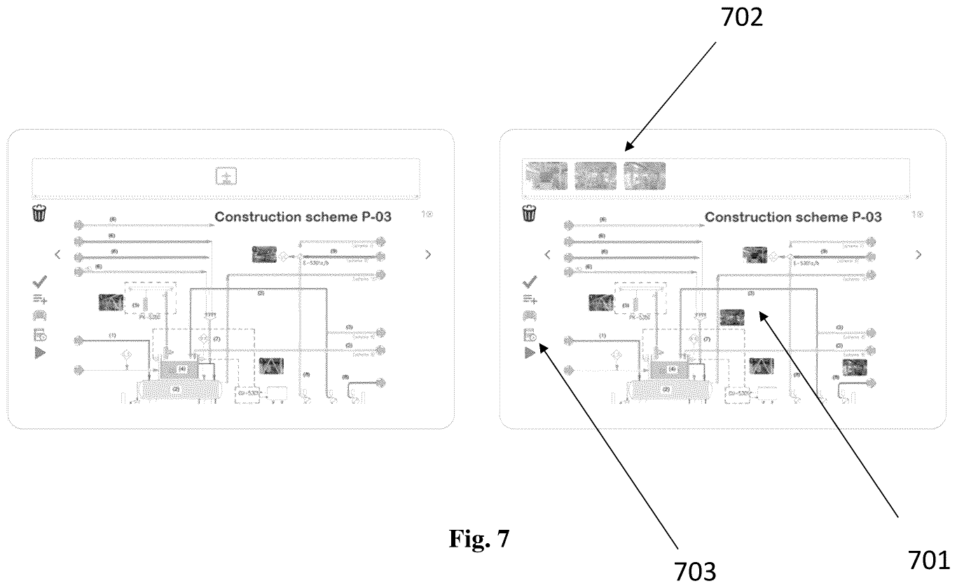

FIG. 7 shows the graphical user interface (GUI) of the system's editing environment, which is used by the manager to configure virtual spaces by uploading and spatially arranging photographic content. The central portion of the interface (701) displays a digital floor plan or schematic drawing that represents the structure or layout of the physical environment to be virtualized. On the top panel (702), a gallery of media files-such as 360-degree panoramic images and standard 2D photographs-is presented as selectable thumbnails. Content of this gallery is used to represent different states of the progress, taken in different time instants.

Each image can be dragged and dropped onto a corresponding location within the floor plan. When an image is positioned, the system automatically associates spatial coordinates with the image file, stores metadata including timestamp, file type (360° or 2D), and any user annotations. These elements are logged in a backend configuration file, typically in structured data format (e.g., JSON or XML), which is later used by the virtual tour engine to define navigation links and transition logic.

The interface also includes command buttons (703) for uploading additional plans or images, deleting or reassigning media, and saving the current project state. This setup allows even non-technical users to construct a coherent, navigable representation of a real environment, integrating visual perspectives within an architectural framework.

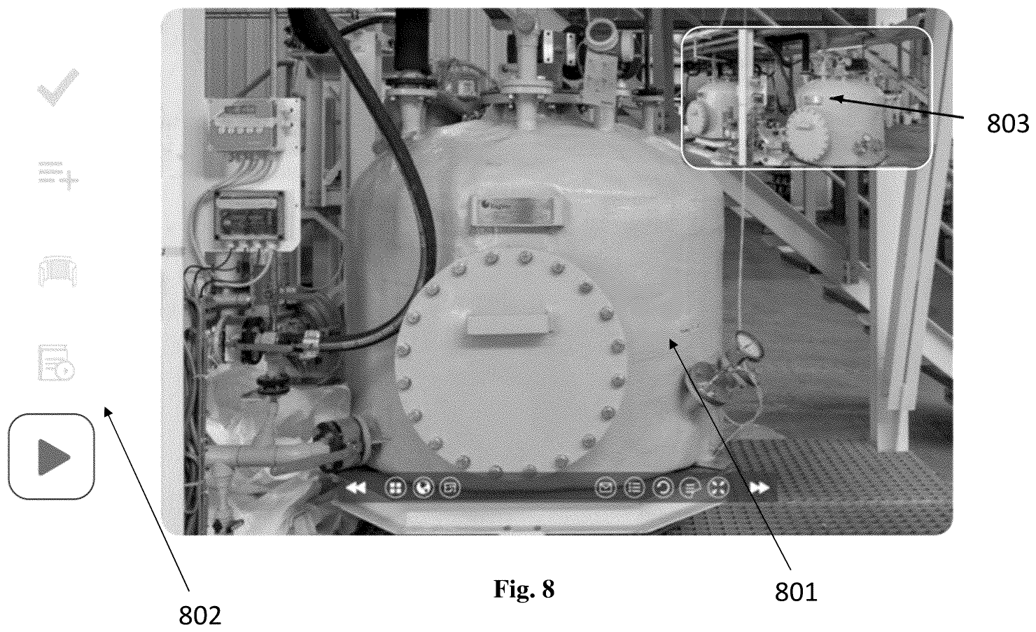

FIG. 8 illustrates the interface component that allows the manager to see, in real time, exactly what the client is viewing within the virtual environment.

In the center of the screen (801) is a detailed panoramic or 360° image of industrial equipment (e.g., a pressure vessel), enriched with various interactive controls (802) positioned near the image (such as zoom, rotate, navigation, etc.).

On the top right corner of the main view, an inset window (803) (picture-in-picture) displays a live mirror of the user's current field of view, synchronized in real time.

On the left sidebar (802), several functional icons allow: Session confirmation, Annotation or note-taking, possibly switching to VR mode or multi-user mode, Session play/start button.

This visual feature exemplifies the synchronous viewing system described in the patent, allowing the manager to guide, annotate, and assist the client interactively based on what the client is focusing on.

It also enhances collaborative remote inspections and commercial walkthroughs by ensuring that both parties share an aligned spatial context, improving efficiency and understanding.

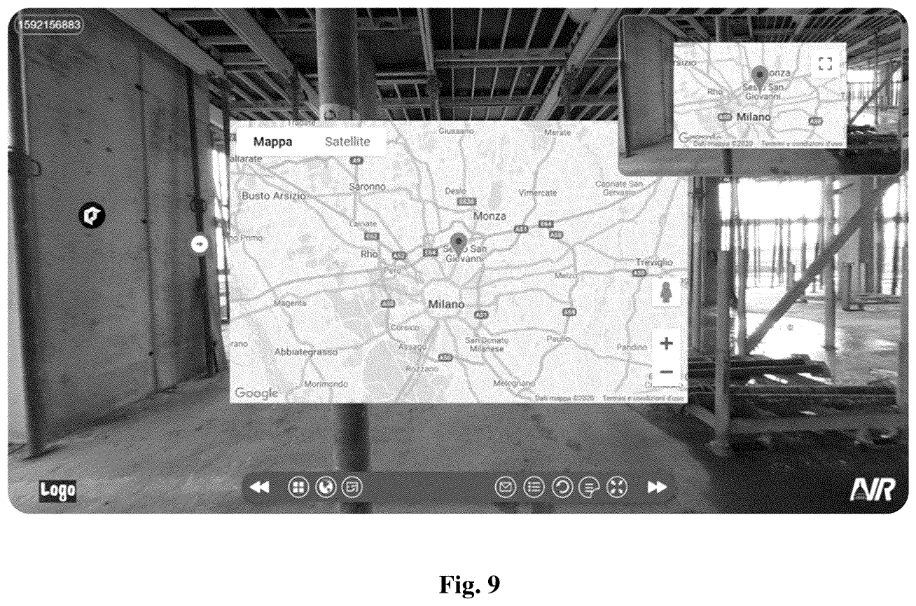

FIG. 9 illustrates a functional module of the disclosed system that enables spatial anchoring of a virtual environment through geolocation tools integrated into the user interface.

The main area of the interface displays a geographic map view (e.g. powered by a third-party mapping service such as Google Maps), centered on a real-world location (e.g., Milan). A location marker is placed on the map, pinpointing the physical position corresponding to the virtual environment being explored.

A secondary inset window in the upper-right corner shows client view, further enhancing seller-client interactions.

The background consists of an image of a physical environment (e.g., a construction site), over which the map is layered. This configuration exemplifies the system's capability to blend digital and real-world content.

A functional toolbar on the bottom side includes interactive icons that allow:
Toggling between different map views (e.g., satellite, standard);
Zooming in/out and panning the map;
Entering or editing GPS coordinates;
Linking the current position with media resources.

In the top-right corner, a project identifier code is displayed, which allows tracking and retrieval of the corresponding environment configuration.

This interface is implemented as part of the system's optional geolocation module, which:
Retrieves map data via geographic APIs (e.g., Google Maps API);
Allows the user to place anchor points on the map via click;
Stores the resulting coordinates in a project-specific database; and
Links these coordinates with spatial metadata from associated photos, videos, or panoramic images.

This capability enables context-aware navigation, logistical planning, and spatial coherence between the virtual representation and the physical world. It supports use cases such as remote site inspections, construction tracking, and geographically distributed collaboration.

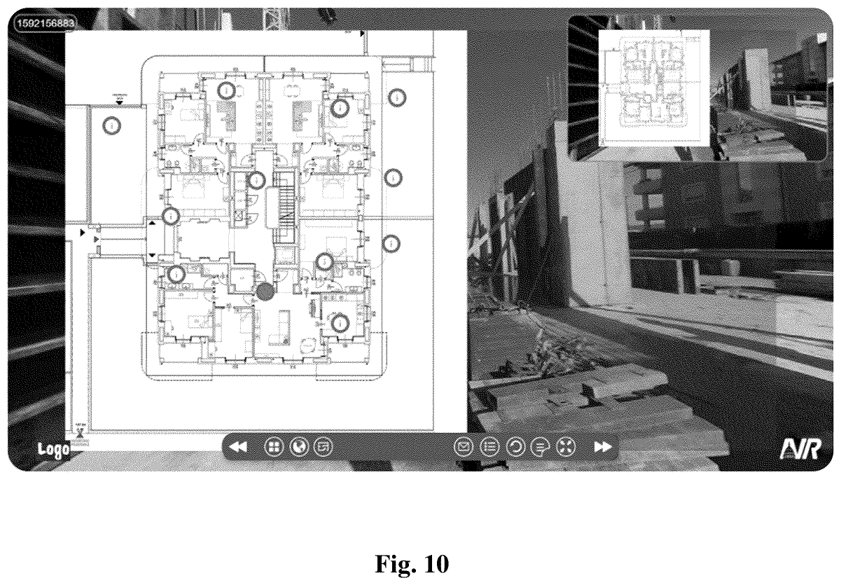

FIG. 10 depicts a different running status where the previously loaded architectural site plan of the plant is shown. A user can select the different locations by selecting the references placed on the map and be virtually brought to that location.

While the invention has been described in connection with the above-described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

The invention claimed is:

1. A system to collaboratively view a virtual representation of an environment or of products inserted in an environment, comprising:
a plurality of local stations, each comprising a processor, a memory, a monitor, and means for data transmission and reception; and
a WEB server configured to:
store a digital replica of the environment composed of spatially anchored media objects;
allow real-time bidirectional synchronization of directional indicators between the plurality of local stations;
enable a placement and interaction with multimedia elements and contextual annotations within the environment; and
adapt a graphical interface based on user role and session state.

2. The system according to claim 1, wherein the directional indicators comprise vector attributes, scene identifiers, and orientation data rendered in real time to guide a user's viewpoint.

3. The system according to claim 1, wherein the multimedia elements are anchored to spatial coordinates and are associated with metadata including timestamp, author, and object type.

4. The system according to claim 1, wherein the WEB server is further configured to:
capture temporal snapshots of an environment layout and media configuration;
store the temporal snapshots in a version-controlled format comprising metadata and layout state; and
allow a comparison between the temporal snapshots to detect modifications over time.

5. The system according to claim 4, wherein differences between the temporal snapshots are rendered using a graphical overlay comprising transparency masks, color-coded highlights, and numbering, computed by a GPU.

6. The system according to claim 4, wherein each snapshot is tagged with semantic milestones and associated timestamps for filtering and reporting.

7. The system according to claim 1, wherein the system is configured to extract geolocation metadata from images and anchor media objects to a digital map interface for spatial navigation.

8. The system according to claim 1, wherein the WEB server comprises a processing unit configured to assign floorplan coordinates to uploaded media via a drag-and-drop GUI.

9. The system according to claim 1, wherein one of the plurality of local stations is a customer station, and wherein the customer station includes a VR viewer and the WEB server is configured to generate VR-compatible session streams.

10. The system according to claim 1, wherein the multimedia elements include pre-recorded 360° videos that can be played and commented on in real time by a manager.

11. The system according to claim 1, wherein the graphical interface of the user allows a Region Of Interest (ROI) selection and customized zoom for enhanced media interaction.

12. The system according to claim 1, wherein a manager may configure a predefined sequence of scenes connected by vector arrows to guide autonomous navigation.

13. The system according to claim 1, wherein directional guidance markers disappear from a customer's view upon directional alignment with an indicated vector.

14. A process to collaboratively view a virtual environment using a system according to claim 1, comprising:
initiating a session between a manager and a customer through a synchronized interface;
displaying a same environment on the plurality of local stations in real time;
enabling the manager to insert directional guidance visible to the customer;
enabling the manager and the customer to interact with embedded multimedia content and annotations; and
dynamically adjusting user interface elements based on session role and current environment state.

15. The process according to claim 14, wherein the customer may insert visual markers that are rendered in real time on an interface of the manager.

16. The process according to claim 14, wherein the embedded multimedia content comprises images, audio, video, and 3D vector objects anchored to specific locations within the environment.

17. The process according to claim 14, further comprising:
capturing a state of the environment with media layout and metadata;
comparing the state of the environment with a previously captured state; and
rendering graphical overlays showing differences between the state of the environment and the previously captured state.

18. The process according to claim 17, wherein a rendering of the differences is computed using GPU acceleration and is navigable via a timeline interface.

19. The process according to claim 14, further comprising filtering displayed media based on semantic tags or work phases defined by the manager.

20. The process according to claim 14, wherein directional markers are dynamically updated by cursor orientation at placement time and stored with a target reference.
